(19) United States
(12) Patent Application Publication
(10) Pub. No.: US 2014/0127342 A1
(43) Pub. Date: May 8, 2014

(54) Beltless pretzel dough rolling machine

(71) Applicant: Michelle Rene Gallus-Pittsenbargar, Las Cruces, NM (US)

(72) Inventors: Michelle Rene Gallus-Pittsenbargar, Las Cruces, NM (US); David Michael Gallus, Las Cruces, NM (US); Moret Michelle Gallus, Las Cruces, NM (US); Robert Michael Gallus, Las Cruces, NM (US)

(21) Appl. No.: 13/998,488

(22) Filed: Nov. 5, 2013

Related U.S. Application Data
(60) Provisional application No. 61/796,242, filed on Nov. 5, 2012.

(51) Int. Cl. A21C 3/02

(52) U.S. Cl. CPC A21C 3/024
USPC 425/367

(57) ABSTRACT

This invention relates to an apparatus for forming strands or rods of dough from a random but generally spherical shaped quantity of dough. The apparatus is comprised of three rigid co-rotating rollers, two of which are static, and the third roller which is movable, which gradually reduces the space allowed for the rotating dough to reside. The dough bolus is formed into a dough strand wherein all the rollers are still rotating. Retraction of the movable roller will allow for the newly formed strand of dough to exit the apparatus. The strand of dough is then ready for twisting into a pretzel shape. The newly twisted pretzel dough is then glazed, salted and then baked to produce a finished pretzel.

### CROSS-REFERENCE TO RELATED APPLICATIONS

This application converts provisional utility patent application No. 61/796,242 filed on Nov. 5, 2012 into a Non-provisional utility patent application. The entire contents of the provisional utility patent application are hereby incorporated by reference.

### BACKGROUND OF THE INVENTION

The art of pretzel making is replete with many types of dough shaping schemes that convert a random shaped bolus of dough into a strand that can be twisted into the typical pretzel shape. Once twisted into the pretzel shape, the dough is then glazed, salted, and baked to produce a pretzel. However, the shaping of pretzel dough strands, as nearly as can be determined, has in the past been accomplished by hand rolling, flexible belt systems, or with the use of a disc rolling system.

Older style pretzel dough rollers employ one fixed surface, generally with a herringbone grooved surface, and a flexible endless belt to drive the dough bolus into a strand shape. Newer rolling machines employ two counter rotating endless belts to form the pretzel strand shape as shown in U.S. Pat. No. 2,747,524 (Groff). The dough boluses are deposited between a pair of endless, opposite traveling aprons or belts. The function of these belts is to roll the dough pieces out into elongated strands. In FIG. 1 the lower belt assembly comprises a lower belt 84 and an upper belt 85, both of which form a wide endless belt. Referring now more particularly to FIG. 1 and FIG. 2, the lower belt 84 passes over an idler roller 86 which is mounted on a shaft that is appropriately mounted in the frame of the machine.

It also passes over a drive roller 87 that is carried by a shaft 88 and said shaft carries a sprocket over which passes a chain 90. The top flight of the bottom belt 84 is represented at 92 in FIG. 2. This top flight passes over a thin stainless steel plate 93 which is bowed upwardly from side to side throughout its length so as to impart a corresponding shape to the top flight 92. This stainless steel plate 93 is supported by a wooden table 94 which is in turn supported by the structure that is carried by the frame of the machine.

The top belt 85 passes over an idler roller 95 and also over a driving roller 96. The latter is mounted on a shaft 97 which carries a sprocket 98. Referring now more particularly to FIG. 2, the bottom flight of the top belt 85 is designated 101. This bottom flight passes over a stainless steel plate 102 which is bowed throughout its length and which imparts a corresponding curvature to the bottom flight 101.

The plate 102 is carried by a wooden support 103 which is susceptible of adjustment to vary the curvature of the plate carried thereby. This bottom flight 101 of the top belt 85 is driven in a direction exactly opposite to that of the top flight 92 of the bottom belt and at a speed of about 60 percent of that of the bottom belt. At this point it is well to note that both the upper and lower belts are provided with mechanisms for varying the tension thereof and also for adjusting the relative distance there between.

There are a number of problems with the prior art system as seen in FIG. 1. One is that the moving sprockets 98 and drive roller 87 can cause serious injury to the operators of the machinery. Another problem with the prior art system is sanitation issues due to the porosity of the materials used on the belts 84 and 85 of FIG. 1.

Yet another disadvantage of the prior art system is high maintenance and costs due to shifting of the endless belts 84 and 85 which can cause wear on the materials used and requires more energy to operate and in turn destroy said materials.

Another disadvantage of the prior art system in FIG. 1 is a low range of variability of only 120 to 180 pretzels per minute, therein causing problems of over production.

A further disadvantage of the prior art system in FIG. 1 is irregular shaped strands and inconsistencies in the finished dough strand surface, due to the finite rolling time, therein causing flavors to leak through the imperfections of the skin of the dough. The final disadvantage of the prior art system in FIG. 1 can cause ergonomic issues in the facility due to the substantial square footage required.

### SUMMARY OF THE INVENTION

Accordingly, this invention is directed to optimal reshaping of a dough bolus, or a generally round mass of dough into a twistable dough strand without the use of hand rolling or belts for retail bakery establishments.

The preferred reshaping method is accomplished by inserting the dough bolus into the center area of three co-rotating rigid rollers. Once the dough bolus is trapped between the three rollers and is rotating, the single movable roller travels towards the two fixed rollers, this effectively reduces the inter-roller cavity cross section, and along with the rolling movement, induces the dough bolus to form a rod-like shape or strand. This continues until the desired aspect ratio of the strand is achieved. While all of the rollers are rotating, retraction of the movable roller will allow the newly formed strand to exit the roller cavity once a space between rollers exceed the reduced diameter of the strand.

A belt-less, totally rigid roller system to shape a dough strand has many advantages over a hand or belt rolling system. These advantages include improved sanitation by the application of a sealed rolling surface, low maintenance costs due to rugged equipment material, and an easily repaired system. The rigid dough roller system allows for a smooth surface and even rolling pressure which in turn seals in flavors and creates a superior pretzel. The rigid roller system also provides a uniform dough texture and consistent dough strand cross-section for consistent dough quality.

Unlike a belt system wherein excess horsepower is necessary due to belt friction, a rigid roller system also allows for low operating costs due to energy saving methods by reducing required horsepower needed for shaping dough. An additional advantage is having the ability to run at a wide range of speeds according to the desired quantity of pretzels required. In addition, this system provides more safety than a moving belt system which can cause serious injury. A rigid roller system has the advantage of infinite rolling time unlike a belt rolling system which is time limited. The rigid roller system makes consistent length dough strands with straight ends for streamlined pretzel twisting and baking.

Where a belt rolling system requires a substantial amount of floor space, a rigid dough rolling system can be made to occupy a small amount of floor space while maintaining high production rates.

Finally, there is an aesthetic advantage of a rigid roller system which allows for the ability to use clear materials as rigid rollers for customer entertainment.

Other objects and advantages of the present invention will become more apparent to those persons having ordinary skill in the art to which the present invention pertains from the foregoing description taken in conjunction with the accompanying drawings.

### BRIEF DESCRIPTION OF DRAWINGS

FIG. 1 is a side view of a prior art belt roller assembly;

FIG. 2 is a transverse vertical section through the belt roller assembly of the prior art system of FIG. 1;

FIG. 3 is a perspective view of the current invention, showing the first step of the rolling cycle;

FIG. 4 is a view similar to FIG. 3, showing a second step of the rolling cycle;

FIG. 5 is a view similar to FIG. 3, showing a third step of the rolling cycle;

FIG. 6 is a view similar to FIG. 3, showing a forth step of the rolling cycle, where the completed dough strand has been formed;

FIG. 7 is a view similar to FIG. 3, showing the ejection of the newly formed dough strand from the current invention;

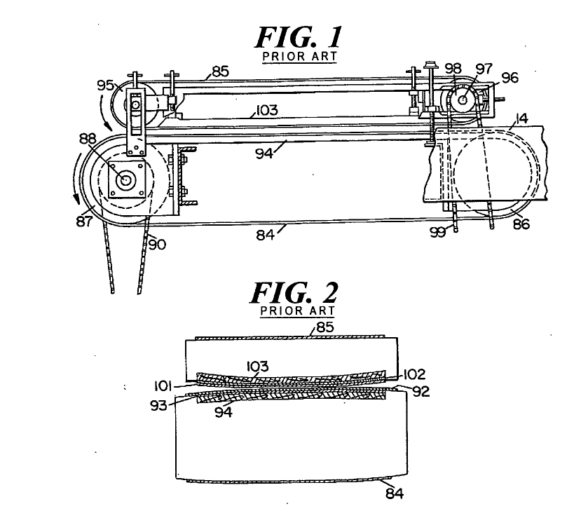

### DETAILED DESCRIPTION OF PREFERRED EMBODIMENTS OF THE INVENTION

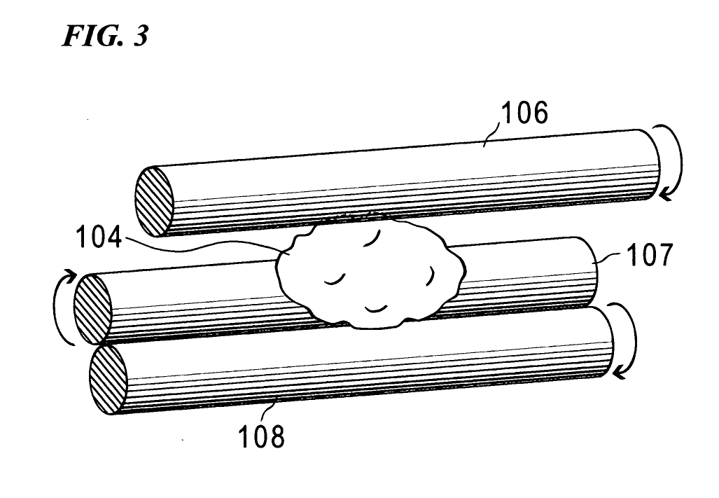

A system of the present invention for beltless dough rolling is illustrated in the drawings FIGS. 3-7. A typical dough rolling cycle will be described below. First, referring hitherto the rollers 106, 107 and 108 are arranged in a fashion to create a long inter-roller cavity having a larger opening between static roller 107 and movable roller 106 than the opening between static roller 108 and movable roller 106. The inter-roller cavity is defined as the void between three rollers where a bolus of dough can be trapped. A dough bolus is defined as a generally round mass of pretzel dough to be shaped into a twistable dough strand.

A dough bolus 104 is deposited into the middle of the inter-roller cavity through the opening between static roller 107 and movable roller 106 in FIG. 3 while all rollers 106, 107 and 108 are rotating around their respective longitudinal axes.

Once the dough bolus 104 begins contacting the rollers 106, 107 and 108, the dough bolus starts to rotate around its center of mass in the opposite direction of the rollers 106, 107 and 108, with its axis of rotation respectively parallel to that of the rollers 106, 107 and 108 axes.

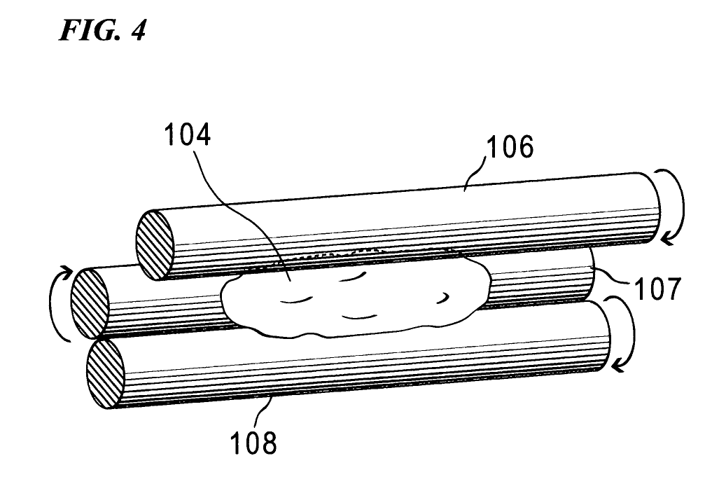

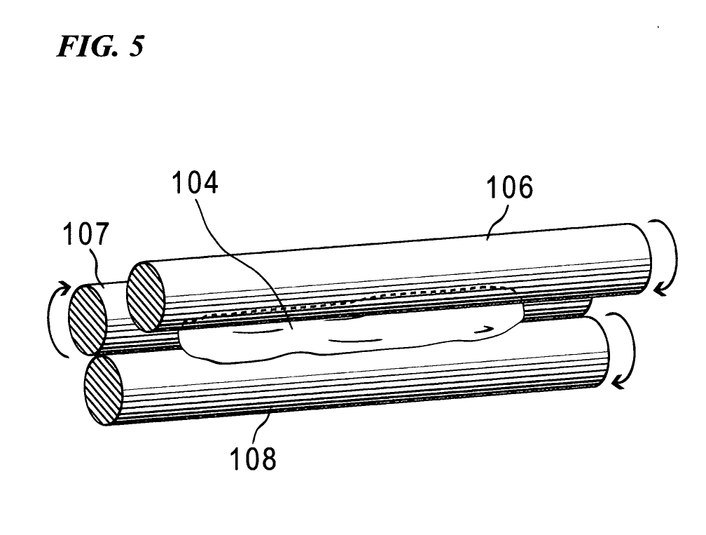

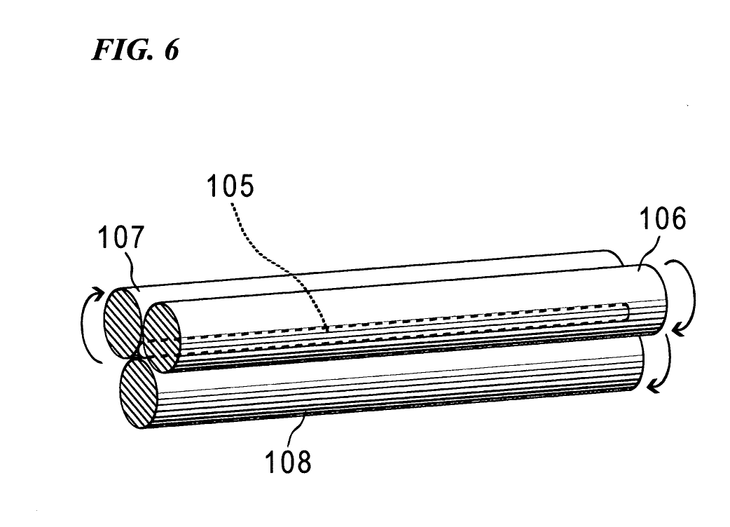

The dough bolus 104 is then acted upon by the movable roller 106, which moves toward the other two static rollers 107 and 108 in FIG. 4, thereby forcing the dough bolus 104 to conform to the smaller inter-roller cavity by reshaping along the long dimension of the inter-roller cavity in FIG. 5 to form a dough strand 105 in FIG. 6. The position where the rollers are closest without touching is defined as the closest packed position. If all three rollers have identical diameters, the closest packed position forms an equilateral triangle drawn through all three roller centers. The rollers cannot be allowed to touch because co-rotating rollers have counter rotating surfaces that would gall during operation.

Once the dough strand 105 reaches the desired aspect ratio, the movable roller 106 stops moving toward the other two static rollers 107 and 108, and resides there until the desired surface smoothness of the dough strand 105 is achieved, there upon the movable roller 106 retracts, and no longer contacts the dough strand 105 surface.

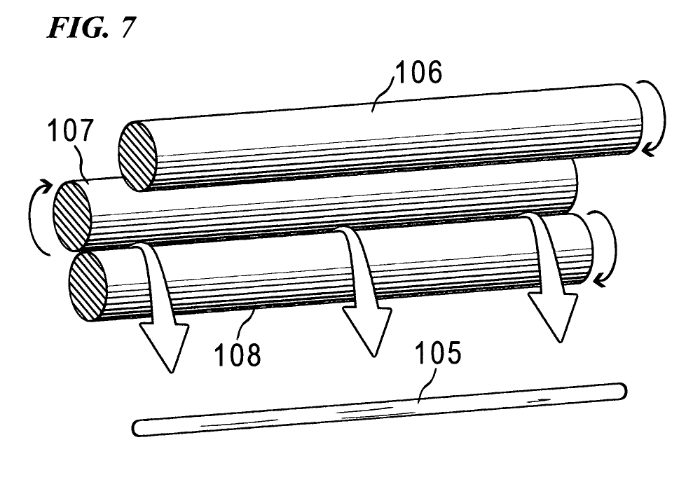

Since the dough strand 105 no longer contacts the movable roller 106, it is forced out the opening between static roller 108 and movable roller 106 by the rotation of the lower roller 108 in FIG. 7 and the influence of gravity. The apparatus is now ready to receive a new dough bolus 104 in FIG. 3 and the process can then repeat.

The range of lengths of the rollers can be between one and a half inches to eight feet long. Rollers on the same device do not have to be of identical length. A dough strand below one and a half inches of length is impractical for a retail establishment. A dough strand greater than eight feet long is also impractical for a retail establishment. Roller diameters should be greater than or equal to three eights of an inch to less than or equal to eleven inches. Rollers diameters smaller than three eighths of an inch will produce pretzels with a glaze that is too thick in proportion to the doughy core. Roller diameters greater than eleven inches will produce pretzels with too large of a doughy core that will rip the skin, which in turn will allow flavors to escape.

Rollers of various diameters could be used on the same device. Also, a single roller can vary in diameter along the length of the roller so long as the above limits are not exceeded and the rollers do not touch at any point during operation. Any of the above described combinations can be used as long as the relative tangential speed of any rollers do not exceed two feet per second. One roller can lead any other roller in tangential velocity, but the absolute value of greater than two feet per second will sheer the dough bolus and destroy the necessary smooth surface that seals flavors within the pretzel. The movable roller can approach the closest packed position by many different paths. The movable roller can arc downward toward the closest packed position in the direction of gravity. The movable roller can also track straight towards the closest packed position. The preferred method for the movable roller to approach the closest packed position is to arc upward against gravity. This preferred method allows for all three rollers to act as a basket to capture the dough bolus when the movable roller is in the retracted position.

The rollers can be made of various materials. If the rollers are constructed of stainless steel it has the advantages of being non-corrosive, easily manufactured, rugged, and can be polished smooth for easy cleaning and is therefore sanitary. If customer entertainment is desired, clear rollers can be constructed with a polished surface that allows viewing of the dough shaping process.

What is claimed is:

1. A mechanism for rolling a dough bolus into a dough strand, comprising:
three co-rotating ridged rollers;
wherein the first and second rollers are fixed, and the third roller is movable;
wherein the roller lengths are no shorter than one and a half inches; and
the roller lengths are no longer than eight feet;
wherein the roller diameters are no smaller than three eighths of an inch; and
the roller diameters are no larger than eleven inches;
further comprising a means of retracting and inserting one roller relative to the closest packing position of all the rollers.

2. The assembly of claim 1 wherein the inter-roller cavity void dimensions at the closest packed position are no less than or equal to one quarter of an inch or greater than or equal to one and a half inches at any point along the roller length.

3. The assembly of claim 1 wherein some rollers are of different diameters.

4. The assembly of claim 1 wherein the tangential speed difference between any two rollers has a range from negative two feet per second to positive two feet per second.

5. The assembly of claim 1 wherein some rollers are of different lengths.

6. The assembly of claim 1 wherein the third movable roller approaches the closest packing position along different paths or arcs, including straight lines.

7. The assembly of claim 1 wherein the third roller retracts from the closest packing position to allow entry of a dough bolus into the inter-roller cavity.

8. The assembly of claim 1 wherein the third roller moves towards the closest packed position in order to reshape a dough bolus into a dough strand.

9. The assembly of claim 1 wherein after the dough strand has formed in the inter-roller cavity, retraction of the movable roller induces the dough strand to be ejected from between one of the fixed rollers and the movable roller.
